(19) United States
(12) Patent Application Publication
(10) Pub. No.: US 2004/0174066 A1
(43) Pub. Date: Sep. 9, 2004

(54) Spoke for a tensioned spoked wheel assembly

(76) Inventor: Rolf Dietrich, Toledo, OH (US)

Correspondence Address: PURDUE LAW OFFICES, 2735 N. HOLLAND-SYLVANIA ROAD, SUITE B-2, TOLDEO, OH, 43615

(21) Appl. No.: 10/804,504

(22) Filed: Mar. 19, 2004

Related U.S. Application Data
(63) Continuation-in-part of application No. 10/262,315, filed on Sep. 30, 2002.
(60) Provisional application No. 60/325,827, filed on Sep. 28, 2001.

(51) Int. Cl. B60B 1/02

(52) U.S. Cl. 301/104

(57) ABSTRACT

A spoke for a tensioned spoke wheel is disclosed. The spoke comprises a shaft having first and second ends. A first segment of the shaft, adjacent the first end, has a given cross-sectional area, while a second segment of the shaft has a cross-sectional area less than the given area. The second segment is adjacent, and toward the second end from, the first. The surface of a part of the unthreaded portion of the first segment is shaped to form at least two opposed, flat, torque transmitting surfaces.

### CROSS-REFERENCE TO RELATED APPLICATION

This is a continuation in part of application Ser. No. 10/262,315, filed Sep. 30, 2002; the benefit of the filing date of Provisional Application 60/325,827, Filed Sep. 28, 2001 is claimed.

### STATEMENT CONCERNING FEDERALLY SPONSORED RESEARCH OR DEVELOPMENT

Not applicable

### REFERENCE TO A “SEQUENCE LISTING”

Not applicable

### BACKGROUND OF THE INVENTION

(1) Field of the Invention

The present invention relates generally to wheels for human powered vehicles such as bicycles, wheel chairs and the like, and especially to a novel spoke therefor.

(2) Description of Related Art including Information Disclosed Under 37 CFR 1.97 and 37 CFR 1.98

Spokes for wheels for human powered vehicles have been the subjects of numerous innovations over the years.

Known are spokes that have a first given diameter over a major length of the spoke and a first end including an externally threaded portion with a second, given diameter which is larger than the first diameter. Typically, the other, second end of the spoke also has the second given diameter, and terminates in a head, in which case the spokes are known as double butted spokes. Such spokes have reduced wind resistance and improved aerodynamic properties by comparison with spokes that have the second given diameter over their entire length, but are not well suited for use in wheels where the spokes are under a high tension. When a spoke nipple or spoke nut is turned on the threaded end of the spoke until the tension in the spoke gets to be quite high, the spoke end will sometimes turn with the nipple or nut, preventing a desired change in the spoke tension. In other words, the threaded end of the spoke turns with the nipple whereas it is necessary to rotate the nipple, relative to the threaded end of the spoke, in order to change the tension in the spoke. This problem arises also, in high tension applications, in the case of spokes that have a minimal, constant diameter.

U.S. Pat. No. 6,431,035, Aug. 13, 2002, recognizes the problem that a spoke end will turn with the nipple, and suggests a tool which can be used to grip a spoke so that the spoke end can be prevented from turning with the nipple, thus enabling adjustment.

The website of DT Swiss AG, CH-2500 Biel, Switzerland, discloses a “DT New Aero” Spoke with a flattened central portion which has a minimum thickness of 1.0 mm and a maximum thickness of 2.0 mm.

### BRIEF SUMMARY OF THE INVENTION

The present invention is an improved spoke for a tensioned spoke wheel. The spoke comprises a shaft having first and second ends. A first segment of the shaft, adjacent the first end, has a given cross-sectional area and is threaded, while a second segment of the shaft has a cross-sectional area less than the given area. The second segment is adjacent, and toward the second end from, the first. The surface of a part of the unthreaded portion of the first segment is shaped to form at least two opposed, flat, torque transmitting surfaces. The flat, torque transmitting surfaces can be formed by squeezing a portion of the spoke near the threads to produce two opposed flat surfaces on the side of the spoke. In the case of a double butted spoke, such flats are preferably formed within the larger diameter end region of the spoke. When it is desired to adjust the tension on such a spoke, the flats are easily engaged by a tool, which can be held to prevent the end of the spoke from rotating when the nipple or nut is turned, thereby facilitating the desired change in spoke tension. It is usually preferred that, except for the flats thereon, the spokes of the invention be circular in cross section.

Accordingly, it is an object of the present invention to provide an improved spoke, especially a butted spoke.

It is a further object of the invention to provide a simple method for producing an improved spoke.

It is a further object of the present invention to provide a graduated spoke which is especially suited for high tension applications in spoked wheels, especially for human powered vehicles.

It is still another object of the invention to provide a graduated spoke which has a portion of sufficiently small diameter that that portion is subject to twisting when a nipple is turned onto the graduated spoke to apply a high tension thereto.

These and other objects and advantages of spokes according to the present invention will be fully appreciated by those skilled in the art upon reviewing the disclosures herein.

### BRIEF DESCRIPTION OF THE SEVERAL VIEWS OF THE DRAWING

FIG. 1 is a side view of a spoke according to the present invention.

FIG. 2 is a front view of the spoke shown in FIG. 1.

FIG. 3 is a side view of another spoke according to the present invention.

FIG. 4 is a view in perspective showing a wheel comprising a rim, a hub and 18 of the spokes of FIGS. 1 and 2.

FIG. 5 is a side view of another embodiment of a spoke according to the present invention.

### DETAILED DESCRIPTION OF THE PREFERRED EMBODIMENTS

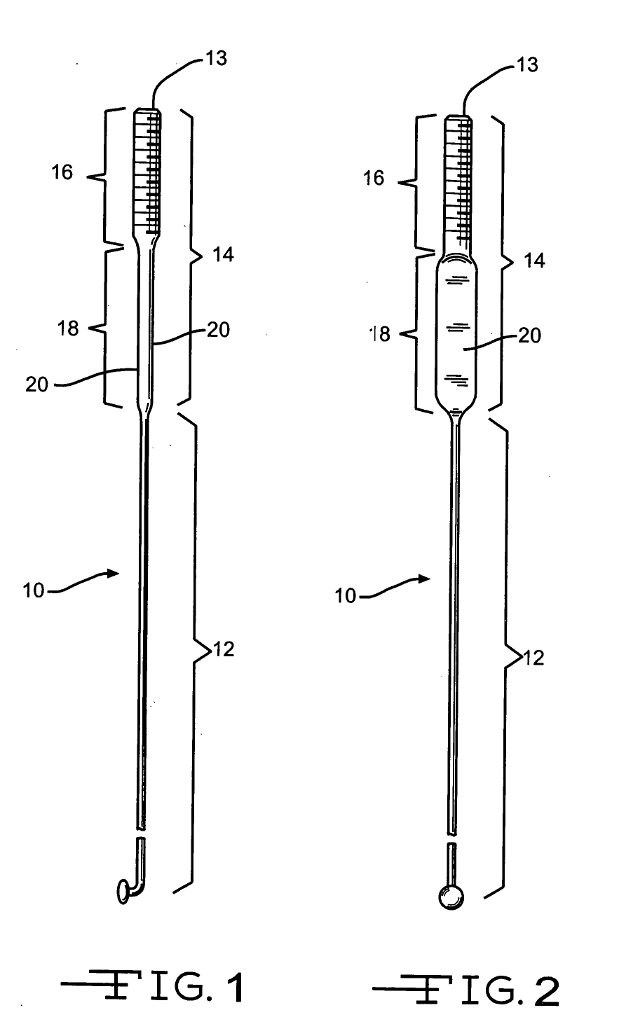

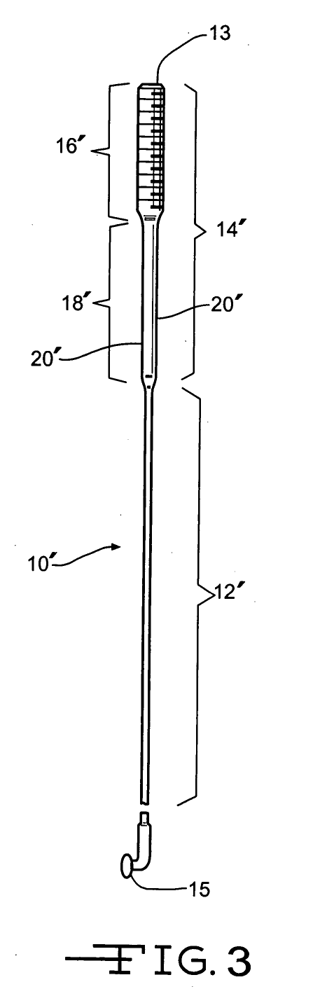

Referring to FIGS. 1 and 2, a graduated spoke is indicated generally at 10. The spoke comprises a central region 12 and an end region 14. A known, graduated spoke has a 17 gauge central region and a 14 gauge end region. Such a spoke was modified, according to the present invention, to produce the spoke 10. The central region 12 of the spoke 10 is 17 gauge and has a nominal diameter of approximately 58 thousandths of an inch. The end region 14 of the spoke 10 is 14 gauge and has a nominal diameter of approximately 80 thousandths of an inch. A portion 16 of the end portion 14 is threaded.

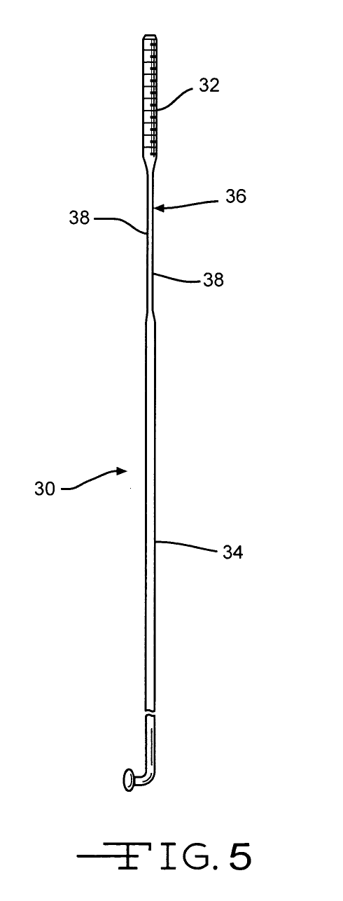

According to the present invention, an unthreaded portion 18 of the end region 14 has been modified to produce two torque transmitting surfaces comprising flat surfaces 20. The modification was achieved by positioning the portion 18, and an adjacent portion of the central region 12, between the jaws of a vise, and closing the jaws to deform the portion 18. Once the jaws closed to the point where they engaged the central portion 12, the force required to close the jaws of the vice further became much greater and no further force was applied to the jaws. When the spoke was released from the vise, the flats 20 were completely formed. The flats 20 were about 65 thousandths of an inch apart. In other words, the flats were separated by a distance, which was a few thousandths of an inch greater than the diameter of the central region 12 of the spoke 10, and perhaps 15 thousandths of an inch less than the diameter of the spoke portion 18. In a wheel (see FIG. 4), this narrowed portion 12 of the spoke 10 will present a smaller profile as it rotates with the wheel, thereby enhancing the aerodynamics of the wheel.

The region 12 of the spoke 10 is sufficiently small in diameter (approximately 0.058 inch) that, when the spoke is conventionally installed as shown in FIG. 4, between a rim 22 and a hub 24 of a spoked wheel 26, and a nipple 28 is turned onto the threaded portion 16 (FIGS. 1 and 2) of the spoke 10, until the tension in the spoke gets to be quite high, the spoke end will sometimes turn with the nipple, preventing achieving a desired spoke tension unless the flats 20 are gripped by a suitable gripping tool. When the flats 20 of a spoke 16 are so engaged, turning of the end of that spoke is prevented while the nipple is turned on the threaded portion 16 of the spoke, even when the spoke 10 is highly tensioned.

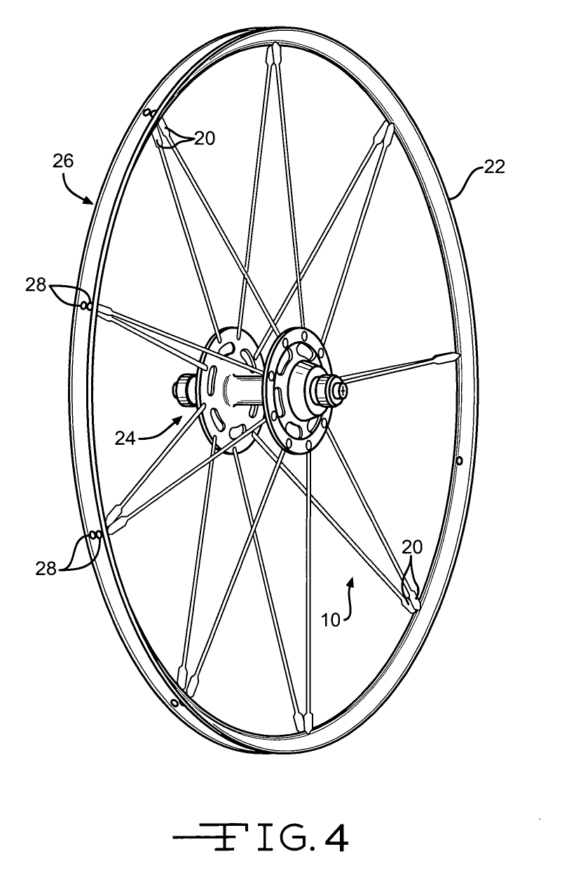

Referring to FIG. 3, another spoke according to the invention is indicated generally at 10′. The spoke 10′ comprises a central region 12′ and end regions 14′ and 15. The central region 12′ of the spoke 10′ can be seventeen gauge and have a nominal diameter of approximately 58 thousandths of an inch, which, as indicated above, is sufficiently small that, when the spoke 10′ is installed in a wheel and under high tension, turning a nipple on the spoke to increase the tension will sometimes cause the central region 12′ to rotate. The end regions 14′ and 15 of the spoke 10′ can be fourteen gauge and have nominal diameters of approximately 80 thousandths of an inch. A portion 16′ of the end portion 14′, which is adjacent an end 13 of the spoke 10′, is threaded.

An unthreaded portion 18′ of the end region 14′ of the spoke 10′ has been modified to produce two flat surfaces 20′, which are torque transmitting surfaces. The modification was achieved by positioning the portion 18′, and an adjacent portion of the central region 12′, between the jaws of a vise, and closing the jaws to deform the portion 18′. Once the jaws closed to the point where they engaged the central portion 12′, the force required to close the jaws of the vice further became much greater and no further force was applied to the jaws. When the spoke was released from the vise, the flats 20′ were completely formed. The flats 20′ were about 65 thousandths of an inch apart. In other words, the flats were separated by a distance, which was a few thousandths of an inch greater than the diameter of the central region 12′ of the spoke 10′, and perhaps 15 thousandths of an inch less than the diameter of the spoke portion 18′.

Another spoke according to the invention is indicated generally at 30 in FIG. 5. The spoke 30 comprises a threaded end region 32 and a body region 34, which can be seventeen gauge and have a nominal diameter of approximately 58 thousandths of an inch, which, as indicated above, is sufficiently small that, when the spoke 30 is installed in a wheel and under hight tension, turning a nipple on the spoke to increase the tension will sometimes cause the body region 34 to rotate. The end region 32 of the spoke 30 can also be seventeen gauge, or it can be fourteen gauge and have a nominal diameter of approximately 80 thousandths of an inch.

A portion 36 of the body region 34 of the spoke 30 has been modified to produce two flat surfaces 38, which are torque transmitting surfaces. The modification was achieved by placing a portion of the body region 34 between the jaws of a vise, and closing the jaws until they were about 43 thousandths of an inch apart to deform the body region 34 and form the flat surfaces 38. When the spoke was released from the vise, the flat surfaces 38 were completely formed, and were about 43 thousandths of an inch apart.

It will be appreciated that the instant invention is a spoke for a tensioned spoke wheel of a bicycle or the like, and that the spoke, when installed in a tensioned spoke wheel with a nipple threaded into a threaded portion of a first segment of the spoke, is one which, because a portion thereof has a sufficiently small cross section and a sufficiently great length, is subject to rotation therewith when the nipple is rotated. The spoke comprises a shaft having first and second ends, a first segment of the shaft adjacent the first end has a threaded portion and an unthreaded portion which is adjacent to the threaded portion and is between the threaded portion and the second end. The shaft also has a second segment which is adjacent, and toward the second end from, the unthreaded portion of the first shaft segment. The surface of a part of the unthreaded portion of the first segment is shaped to form at least two opposed, flat, torque transmitting surfaces. The unthreaded portion of the first segment of the shaft has a sufficiently large cross-section, the shaped portion of the surface of the first segment is sufficiently close to the threaded portion thereof, or both, that preventing rotation of the shaped portion of the first segment surface prevents rotation of the spoke with the nipple.

In a preferred embodiment, the spoke according to the invention comprises a shaft having first and second ends, and a first segment of the shaft adjacent the first end has a given cross-sectional area, while a second segment of the shaft adjacent, and toward the second end from, the first shaft segment has a cross-sectional area less than the given area. The first segment of the shaft has a threaded portion and an unthreaded portion which is adjacent to the threaded portion and is between the threaded portion and the second end. The surface of a part of the unthreaded portion of the first segment of the shaft is shaped to form at least two opposed, flat, torque transmitting surfaces.

It is preferred that the threads on a spoke according to the invention be formed by rolling, so that the major diameter of the threaded portion of the spoke is greater than the diameter of the segment of the spoke which is threaded.

It will be appreciated that a spoke according to the invention may well have torque transmitting surfaces other than two opposed flat surfaces. For example, the spoke may have four flat torque transmitting surfaces, or more. In the case of a spoke with four torque transmitting surfaces, such surfaces would generally form an angle of ninety degrees with an adjacent torque transmitting surface.

1. A spoke for a tensioned spoke wheel, said spoke comprising
a shaft having first and second ends, a first segment of said shaft adjacent the first end having a given cross-sectional area, and a second segment of said shaft adjacent, and toward the second end from, said first shaft segment having a cross-sectional area less than the given area, said first segment having a threaded portion and an unthreaded portion which is adjacent to said threaded portion and is between said threaded portion and said second end,
wherein the surface of a part of said unthreaded portion of said first segment is shaped to form at least two opposed, flat, torque transmitting surfaces.

2. A method for producing a spoke comprising a shaft having first and second ends, said first end including a threaded portion and an unthreaded portion adjacent to said threaded portion, wherein said unthreaded portion includes at least two torque transmitting surfaces consisting of opposed flat surfaces, said method comprising the steps of
engaging the unthreaded portion of the spoke between two spaced, generally parallel tool surfaces,
advancing the spaced surfaces, one towards the other, until they engage the unthreaded portion of the spoke, and beyond, so that the surfaces permanently and inelastically deform the unthreaded portion to produce the two torque transmitting surfaces, and
releasing the spoke from the tool surfaces.

3. A spoke for a tensioned spoke wheel as claimed in claim 1 wherein, when the spoke is installed in a wheel under tension applied by a nipple or nut into which the spoke is threaded, the cross sectional area thereof is sufficiently small that said second segment is subject to rotation therewith when the nipple or nut is rotated to increase the spoke tension.

4. A spoke for a tensioned spoke wheel as claimed in claim 1 which, except for said flat, torque transmitting surfaces, is generally circular in cross section.

5. A spoke for a tensioned spoke wheel as claimed in claim 1 which additionally has a third segment which is between said second segment and the second end of the spoke, wherein said third segment has a cross-sectional area greater than that of said second segment.

6. A spoke for a tensioned spoke wheel as claimed in claim 5 which, except for said flat, torque transmitting surfaces, is generally circular in cross section.

7. A spoke for a tensioned spoke wheel as claimed in claim 4 wherein the major diameter of the threaded portion of said first segment is greater than the diameter of said first segment of the spoke.

8. A spoke for a tensioned spoke wheel as claimed in claim 6 wherein the major diameter of the threaded portion of said first segment is greater than the diameter of said first segment of the spoke.

9. A spoke for a tensioned spoke wheel, said spoke comprising
a shaft having first and second ends, a first segment of said shaft adjacent the first end having a threaded portion and an unthreaded portion which is adjacent to said threaded portion and is between said threaded portion and said second end, and a second segment of said shaft adjacent, and toward the second end from, said first shaft segment,
wherein the surface of a part of said unthreaded portion of said first segment is shaped to form at least two opposed, flat, torque transmitting surfaces, said spoke, when installed in a tensioned spoke wheel with a nipple threaded onto the threaded portion of the first segment of said spoke, being subject to rotation therewith when the nipple is rotated, and the unthreaded portion of the first segment of the shaft has a sufficiently large cross-section, the shaped portion of the surface of the first segment is sufficiently close to the threaded portion thereof, or both, that preventing rotation of the shaped portion of the first segment surface prevents rotation of the spoke with the nipple.
